(19) United States
(12) Patent Application Publication
(10) Pub. No.: US 2003/0008086 A1
(43) Pub. Date: Jan. 9, 2003

(54) Case and actuator device

(75) Inventors: Tomoshiro Tsukada, Okazaki-shi (JP); Motoyuki Shimizu, Okazaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: AISIN SEIKI KABUSHIKI KAISHA, Kariya-shi (JP)

(21) Appl. No.: 10/143,980

(22) Filed: May 14, 2002

(30) Foreign Application Priority Data
May 14, 2001 (JP) 2001-143189

(51) Int. Cl. B32B 1/02

(52) U.S. Cl. 428/35.7

(57) ABSTRACT

A case is formed by Injection molding of composition of resin and includes an accommodation chamber which is formed therein for holding functional components. The composition of resin contains from 40 to 70 wt % of polybutylene terephthalate resin (PBT) and from 60 to 30 wt % of acrylonitrile-butadlene-styrene (ABS). The case satisfies a superior rigidity, impact load carrying capacity and chemical resistance.

### CROSS REFERENCE TO RELATED APPLICATION

This application is based on and claims priority under 35 U.S.A. § 119 with respect to a Japanese Patent Application 2001-143189 filed on May 14, 2001, the entire content of which is Incorporated herein by reference.

### FIELD OF THE INVENTION

This invention relates to a case and an actuator device. More particularly, the present invention pertains to a case and an actuator device which have superior rigidity, Impact load carrying capacity and chemical resistance.

### BACKGROUND OF THE INVENTION

A conventional door lock device Is described as an example of a prior art The door lock device includes an actuator case which holds functional components such as an open lever, a lock lever and so on, and an antitheft protector which is secured to an outside of the actuator case for improving an impact load carrying capacity of the door lock device and which is formed by a resin being differ from a resin forming the actuator case. However, since the number of parts of this door lock device is large, the structure is complex and the weight thereof is heavy. Further, since the antitheft protector is provided at outside of the actuator case, the door lock device Increases in size and there is a limit to equip the door lock device on various vehicles.

In recent years, approaches which overcome the above drawbacks are carried on. Namely, in order to reduce the number of parts of the door lock device, some of the functional components are incorporated in the actuator case in a body, Further, moderate flexibility is given to the actuator case In order to further improve the antitheft function and it is attempted to abolish the antitheft protector.

As a physicality required to the actuator case for achieving the above structure, however, a rigidity and an impact, load carrying capacity which are contrary to each other are requested. Mainly the rigidity is requested for holding the functional components. The improvement of the impact load carrying capacity by the improvement of the flexibility is requested so as not to be destroyed by a thief. Further, since grease and so on for being smooth the operation of the functional components attaches to the actuator case with high frequency, a chemical resistance such as organic solvent proof and an oil resistance is requested.

In the prior devise, polybutylene terephthalate resin (PBT), polyacetal resin (POM) and so on are used as a material of the actuator case. However, these resin are not always enough to satisfy the above requests and it is impossible to form the actuator case which satisfies the rigidity, the impact load carrying capacity and the chemical resistance.

A need exists for a case and an actuator device which can satisfy the rigidity, the impact load carrying capacity and the chemical resistance.

### SUMMARY OF THE INVENTION

A first aspect of the present invention is a case formed by injection molding of composition of resin and having an accommodation chamber which is formed therein for holding functional components, wherein the composition of resin contains from 40 to 70 wt % of polybutylene terephthalate resin (PBT) and from 60 to 30 wt % of acrylonitrile-butadiene-styrene (ABS).

Further, according to a second aspect of the present invention, an actuator device comprises a case forming a accommodation chamber and functional components disposed in the accommodation chamber, wherein the case is formed by injection molding of composition of resin which contains from 40 to 70 wt % of polybutylene terephthalate resin (PBT) and from 60 to 30 wt % of acrylonitrile-butadiene-styrene (ABS).

### BRIEF DESCRIPTION OF THE DRAWINGS

The foregoing and additional features and characteristics of the present invention will become more apparent from the following detailed description considered with reference to the accompanying drawing figures in which like reference numerals designate like elements and wherein:

FIG. 1 is a graph showing a compounding ratio, test results, conditions after forming and conditions after the maceration in acetone;

FIG. 2 is a view of electron microscopic picture of samples after the maceration in acetone in accordance of a present invention;

FIG. 3 is a view of electron microscopic picture of samples after the maceration in acetone In accordance of comparative examples;

FIG. 4 is a schematic diagram showing a process of an injection molding;

FIG. 5 is a schematic diagram of a door having a door lock device;

FIG. 6 is a view showing an inner structure of the door lock device; and

FIG. 7 is a view showing a bearing portion of a door lock device.

### DESCRIPTION OF THE EMBODIMENTS

Having generally described the present invention, a further understanding of the invention can be obtained now according to embodiments of the present invention and comparative examples with reference to Figures in accompanying drawings.

### \mathring{1} A Sample No. 1 (A Comparative Example 1)

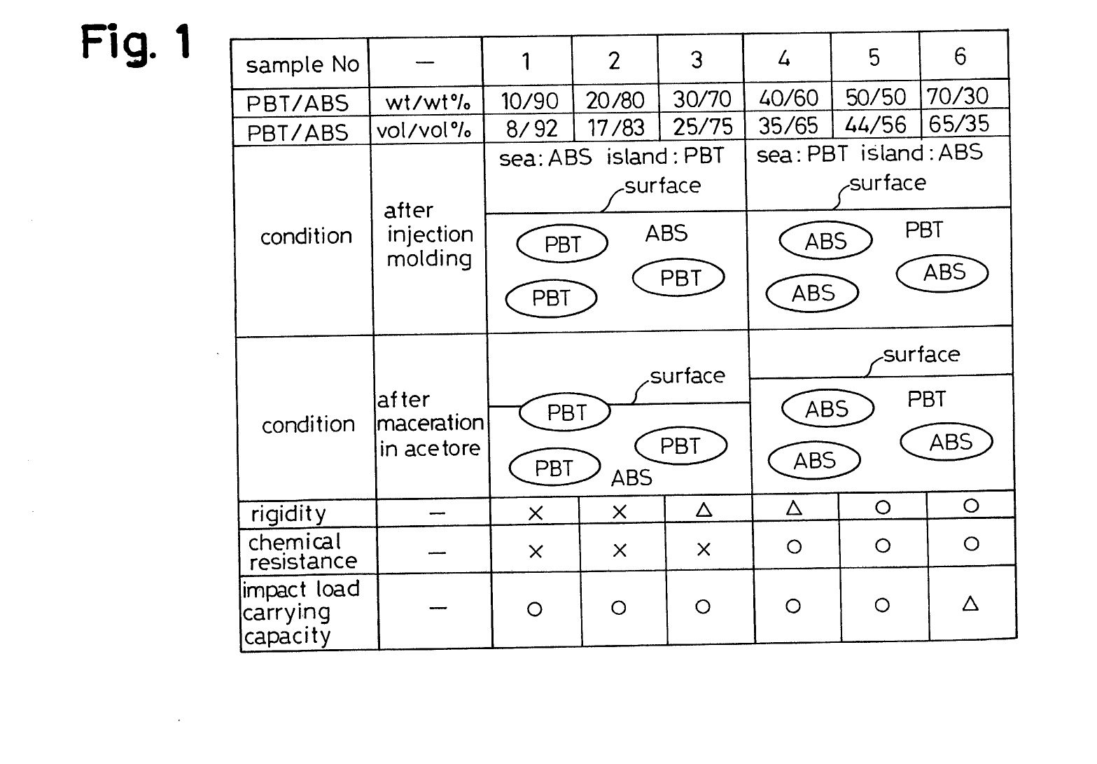

As shown in FIG. 1, the sample No.1 is a case formed by a composition of resin containing 10 wt % of polybutylene terephthalate resin (PBT) and 90 wt % of acrylonitrile-butadlene-styrene (ABS). In vol %, this composition of resin contains 8 vol % of PBT and 92 vol % of ABS. The case of the sample No.1 is formed by injection molding of this composition of resin. In the injection molding, the composition of resin is injected into a cavity of a forming metal mold. The conditions of the injection molding is based on conditions described later in an application form.

### \mathring{2} A Sample No. 2 (A Comparative Example 2)

As shown in FIG. 1, the sample No. 2 is a case formed by a composition of resin containing 20 wt % of PBT and, 80 wt % of ABS. In vol %, this composition of resin contains 17 vol % of PBT and 83 vol % of ABS. The case of the sample No. 2 is formed by injection molding of this composition of resin. In the injection molding, the composition of resin is injected into a cavity of a forming metal mold. The conditions of the injection molding is based on conditions described later in an application form.

### \mathring{3} A Sample No. 3 (A Comparative Example 3)

The sample No. 3 Is a case formed by a composition of resin containing 30 wt % of PBT and 70 wt % of ABS. In vol %, this composition of resin, this composition of resin contains 25 vol % of PBT and 75 vol % of ABS. The case of the sample No. 3 is formed by injection molding of this composition of resin. In the injection molding, the composition of resin is injected into a cavity of a forming metal mold. The conditions of the Injection molding is based on conditions described later in an application form.

### \mathring{4} A Sample No. 4 (A Comparative Example 1)

As shown in FIG. 1, the sample No. 4 is a case formed by a composition of resin containing 40 wt % of PBT and 60 wt % of ABS. In vol %, this composition of resin, this composition of resin contains 35 vol % of PBT and 65 vol % of ABS. The case of the sample No. 4 is formed by injection molding of this composition of resin. In the injection molding, the composition of resin is injected into a cavity of a forming metal mold. The conditions of the injection molding is based on conditions described later in an application form. Fillers such as glass fibers are not combined in the sample No. 4.

### \mathring{5} A Sample No. 5 (A Comparative Example 2)

The sample No. 5 is a case formed by a composition of resin containing 50 wt % of PBT and 50 wt % of ABS. In vol %, this composition of resin, this composition of resin contains 44 vol % of PBT and 56 vol % of ABS. The case of the sample No. 5 is formed by injection molding of this composition of resin. In the injection molding, the composition of resin is injected into a cavity of a forming metal mold. The conditions of the injection molding is based on conditions described later in an application form. Fillers such as glass fibers are not combined in the sample No. 5.

### \mathring{6} A Sample No. 6 (A Comparative Example 3)

The sample No. 6 is a case formed by a composition of resin containing 70 wt % of PBT and 30 wt % of ABS. In vol %, this composition of resin, this composition of resin contains 65 vol % of PBT and 35 vol % of ABS. The case of the sample No. 6 is formed by injection molding of this composition of resin. In the injection molding, the composition of resin is injected into a cavity of a forming metal mold. The conditions of the injection molding is based on conditions described later in an application form. Fillers such as glass fibers are not combined in the sample No. 6.

### Test

With respect to a rigidity, an impact load carrying capacity and a chemical resistance, tests were carried out and test results are shown in FIG. 1. A tensile test piece was formed by the punching of each samples of cases formed as mentioned above. A tensile test was done for each tensile test pieces of the samples and the degree of elasticity of each samples was obtained. Then, the rigidity of each samples was assessed on the basis of the degree of elasticity. In FIG. 1, ◯ shows that the rigidity is high and Δ shows that the rigidity is not very high. X shows that the rigidity is low. With respect to the impact load carrying capacity, the following impulse kill test was done for each samples. A blade edge of a screwdriver is contacted with a surface of each samples and an impact was applied to each samples by striking the screwdriver by a wooden hammer. In FIG. 1, X shows that a hole was formed on the surface of each samples. Δ shows that a hole was not formed but a crack was formed on the surface of each samples. ◯ shows that only the blade edge of the screwdriver was sunk in the surface of each samples.

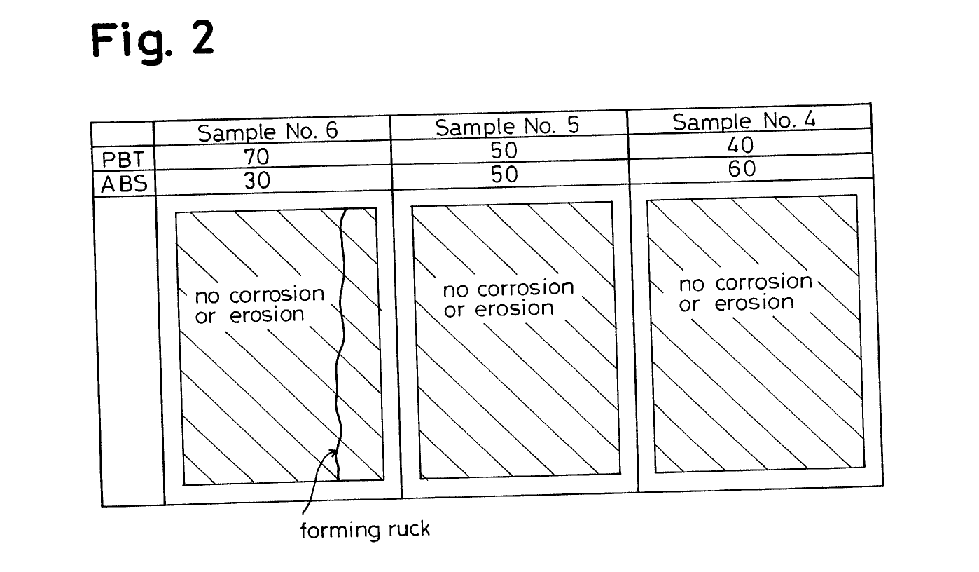

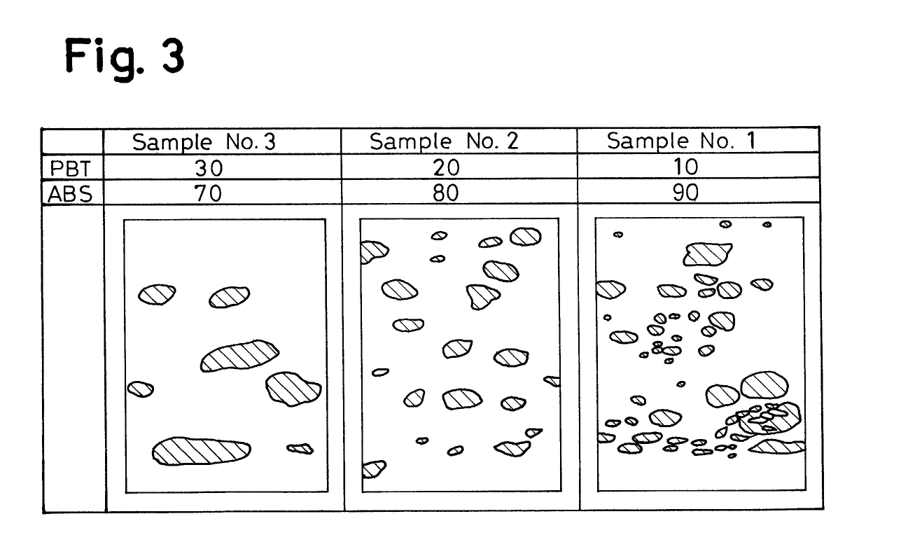

With respect to the chemical resistance, the following test was done. Each samples were soaked in acetone which is an organic solvent (temperature: 23° C.) for 5 minutes. The conditions of the surfaces of each samples were examined by a scanning electron microscope (100 magnifications) without breaking each samples. FIG. 2 and FIG. 3 show views of electron microscopic pictures of each samples.

According to the sample No. 4 in accordance with the present invention, although ABS holds a majority in thrust-to-weight ratio (60%) and in volume-ratio (65%), a corrosion, due to the maceration in acetone was hardly recognized in the electron microscopic picture shown in FIG. 2. Herefrom, it is recognized that the PBT having a good chemical resistance forms a continuous phase (a sea phase) and that the sea phase is appeared on the surface of the case. According to the compounding ratio of PBT/ABS of the sample No. 4, the ABS which holds the majority should form the sea phase and the PBT should form a dispersion phase (an island phase). However, since the corrosion due to the maceration in acetone was hardly recognized, it is thought that the relationship between the sea phase and the island phase is turned over.

Further, according to the sample No. 5 in accordance with the present invention, although 50 wt % of ABS Is contained and 56 vol % of ABS is contained, a corrosion due to the maceration in acetone was hardly recognized in the electron microscopic picture shown in FIG. 2. Herefrom, although the ABS holds a majority in volume ratio, the ABS forms the island phase and the PBT having a good chemical resistance forms the sea phase, and it is recognized that the sea phase is appeared on the surface of the case. In this case, according to the examination by the electron microscopic picture, it is conjectured that the area ratio of the PBT which is appeared on the surface of the case is from 96% to 100%.

Further, according to the sample No. 5 in accordance with the present invention, although 50 wt % of ABS is contained and 56 vol % of ABS is contained, a corrosion due to the maceration in acetone was not recognized in the electron microscopic picture shown in FIG. 2. Herefrom, although the ABS holds a majority in volume ratio, the ABS forms the island phase and the PBT having a good chemical resistance forms the sea phase, and it is recognized that the sea phase is appeared on the surface of the case. In this case, according to the examination by the electron microscopic picture, it is conjectured that the area ratio of the PBT which is appeared on the surface of the case is from 96% to 100%.

Further, according to the sample No. 6 in accordance with the present invention, although 30 wt % of ABS is contained and 35 vol % of ABS is contained, a corrosion due to the maceration in acetone was not recognized in the electron microscopic picture shown in FIG. 2. Herefrom, the PBT having a good chemical resistance forms the sea phase and it is recognized that the sea phase is appeared on the surface of the case with quite a high frequency. In this case, according to the examination by the electron microscopic picture, it is conjectured that the area ratio of the PBT which is appeared on the surface of the case is from 97% to 100%.

According to the sample No. 1, the outline of the island phase is relatively clear in the electron microscopic picture shown in FIG. 3 and the relationship between the island phase and the sea phase based on the compounding ratio of PBT/ABS Is obtained. The PBT of island phase is formed in the ABS of the sea phase. In the electron microscopic picture shown in FIG. 3, it is recognized that the sea phase which is formed by the ABS having a low chemical resistance is eroded due to the maceration in acetone.

According to the sample No. 2, the relationship between the island phase and the sea phase based on the compounding ratio of PBT/ABS is obtained. It is recognized that the PBT of island phase is formed in the ABS of the sea phase.

According to the sample No. 3, the relationship between the island phase and the sea phase based on the compounding ratio of PBT/ABS is obtained. It is recognized that the PBT of island phase is formed in the ABS of the sea phase.

Next, the description of the test results is added as follows.

### \mathring{1} The Sample No. 1 (The Comparative Example 1)

Since the case of the sample No. 1 contains the ABS having a flexibility in large quantities, a superior impact load carrying capacity is obtained but the assessment of the rigidity is not good (X). Therefore, it is undesirable to use the case of the sample No. 1 as a case to which the functional components such as gears required an engaging accuracy are mounted with high accuracy. Further, since the ABS having a low chemical resistance is contained in large quantities, the assessment of the chemical resistance is not good (X). As shown in FIG. 3, it is conjectured that the deterioration of the chemical resistance is caused by the appearance of the ABS having the low chemical resistance on the surface of the case with high frequency.

### \mathring{2} The Sample No. 2 (The Comparative Example 2)

Since the case of the sample No. 2 contains the ABS in large quantities, a superior impact load carrying capacity is obtained but the assessment of the rigidity Is not good (X). Further, since the ABS which has a low chemical resistance forms the sea phase, the chemical resistance of the case is not good (X).

### \mathring{3} The Sample No. 3 (The Comparative Example 3)

The case of the sample No. 3 shows the same tendency as the cases of the sample Nos. 1 and 2. Since the ABS which has a low chemical resistance is contained in large quantities and which forms the sea phase is easy to appear on the surface of the case, the chemical resistance of the case is not enough and the assessment of the chemical resistance is not good (X). The result of the assessment of the rigidity is Δ and it is very undesirable to use the case of the sample No. 1 as a case to which the functional components such as gears required an engaging accuracy are mounted with high accuracy.

### \mathring{4} The Sample No. 4 (The Embodiment 1 of the Present Invention)

In the case of the sample No. 4, In regard to the sample Nos. 1 to 3, the sea phase and the island phase are turned over and the reversal of the phase between the sea phase and the island phase is generated. Namely; although the compounding ratio of the PBT having a good chemical resistance is 40 wt % and is 35 vol %, the PBT forms the sea phase and the chemical resistance of the case is good (◯). According to the sample No. 4, since the PBT forms the sea phase, the PBT having the good chemical resistance appears on the surface of the case with high frequency, Further, the quantity of the PBT which the rigidity is high is a proper quantity, the level of the rigidity and the accuracy of dimension of the case is the same level as the sample No. 3. Further, since the quantity of the ABS having a flexibility is a proper quantity, the assessment of impact load carrying capacity of the case is good (◯).

### \mathring{5} The Sample No. 5 (The Embodiment 2 of the Present Invention)

Since the PBT having a good chemical resistance forms the sea phase in the case of the sample No. 5, the superior chemical resistance is obtained. It is conjectured that the improvement of the chemical resistance is caused by the appearance of the PBT having the good chemical resistance on the surface of the case with high frequency. Further, since the sample No. 5 contains the PBT

In large quantities, the superior rigidity and accuracy of dimension of the case are obtained. Further, since the quantity of the ABS having a flexibility is a proper quantity, the impact load carrying capacity of the case is also good. In the composition of resin of the sample No. 5, since the PBT forms the sea phase and the ABS forms the island phase, although the ABS which the chemical resistance is low is contained, the superior chemical resistance which is a match for the prior case made of only the PBT can be obtained.

### \mathring{6} The Sample No. 6 (The Embodiment of the Present Invention)

Since the PBT having a good chemical resistance forms the sea phase in the case of the sample No. 6, the superior chemical resistance is obtained. Further, since the sample No. 6 contains the PBT In large quantities, the superior rigidity of the case are obtained. However, although the superior chemical resistance and rigidity are obtained, since the quantity of the ABS is small, the flexibility of the case is decreased and thereby the impact load carrying capacity of the case is worse a little. However, a function as a protector which is required in practice against the theft can be expected.

According to the judgment whether the cases of each samples are effected as a case having the function as the protector after making sure the physicality corresponding to the rigidity, the impact load carrying capacity and the chemical resistance, the samples Nos. 4, 5 and 6 of the embodiments in accordance with the present invention are superior. Especially, the sample No. 5 is most superior and satisfies the chemical resistance, the rigidity and the impact load carrying capacity.

### Other Tests

Referring to a table 1, the other tests are described as follows. The meanings of ◯, X, Δ which show the results of the assessment are the same as the above mentioned test.

TABLE 1
assessment result of the case of the door lock device

| | comparative | comparative | comparative | comparative | comparative | | comparative |
|---|---|---|---|---|---|---|---|
| | example 1A | example 2A | example 3A | example 4A | example 5A | embodiment 1A | example 3A |
| composition | POM | POM/soft | PBT/ABS | PBT | PBT/soft | PBT/ABS | PA/PPE |
| | | polymer | | | polymer | | |
| filler | filler | non-reinforcement | GF | GF | GF | non-reinforcement | non-reinforcement |
| fill ration wt % | 5 | — | 15 | 20 | 5 | — | — |
| specific gravity | 1.44 | 1.33 | 1.28 | 1.45 | — | 1.14 | 1.1 |
| tensile | 58 | 44 | 94 | 107 | 48 | 43 | 49 |
| strength(Mpa) | | | | | | | |
| tensile | 20 | 200 | 3 | 2.6 | 12 | >50 | 98 |
| expansion(%) | | | | | | | |
| bending | 92 | 63 | 130 | 176 | 66 | 36 | 74 |
| strength(Mpa) | | | | | | | |
| bending strength | 3000 | 1730 | 5200 | 6600 | 2230 | 1890 | 2019 |
| degree of | | | | | | (1900 * 1) | |
| elasticity(Mpa) | | | | | | | |
| at 23°+00 C. | | | | | | | |
| bending degree of | 1300 | 567 | 2500 | 3300 | 600 | (860 * 1) | — |
| elasticity(Mpa) | | | | | | | |
| at 80° C. | | | | | | | |
| Izod impact | 53 | 150 | 59 | 64 | 140 | 461 | 735 |
| strength (J/m) | | | | | | | |
| heat deformation | 130 | 95 | 187 | 209 | — | 92 | 100 |
| tem.(° C.) | | | | | | | |
| form contraction | 1.7/1.7 | 1.55/1.55 | 0.3/0.6 | — | — | 0.4-0.7 | 1.1-1.4 |
| percentage(%) | | | | | | | |
| (flow/right angle) | | | | | | | |
| coefficient of | 12.4 | | 2.9/9.6 | | | | 9 |
| linear expansion | | | | | | | |
| (×10⁻⁵) | | | | | | | |
| change of dimention | — | — | — | — | — | — | 0.74 |
| (30° C.,95% RH | | | | | | | |
| (%) | | | | | | | |
| result of impulse | X | Δ˜◯ | X | X | X˜Δ | ◯ | Δ˜◯ |
| destroy test | | | | | | | |

* 1 measuring method: based on ISO178

### \mathring{1} A Comparative Example 1A

The comparative example 1A is a case formed by polyacetal resin (POM). The case is formed by injection molding of POM. In the comparative example 1A, the result of the assessment of the impact load carrying capacity was not good (X).

### \mathring{2} A Comparative Example 2A

The comparative example 2A is a case formed by a composition of resin containing 75 wt % of the polyacetal resin (POM) and 25 wt % of the soft-polymer (polyester elastomer). The soft-polymer is dispensed into the POM for applying the Impact load carrying capacity. The case is formed by injection molding of the composition of resin. In the comparative example 2A, the impact load carrying capacity is superior a little and the performance requirement of the case is not satisfied.

### \mathring{3} A Comparative Example 3A

The comparative example 3A is a case formed by a composition of resin containing 80 wt % of PBT and 20 wt % of ABS. The composition of resin is reinforced by a glass fiber (GF). The case is formed by injection molding of the composition of resin. In the comparative example 3A, the impact load carrying capacity deteriorates due to the composition of the glass fiber and the result of the assessment of the impact load carrying capacity was not good (X).

### \mathring{4} A Comparative Example 4A

The comparative example 4A is a case formed by injection molding of the PBT which does not include ABS. In this example, the result of the assessment of the impact load carrying capacity was not good (X).

### \mathring{5} A Comparative Example 5A

The comparative example 5A is a case formed by a composition of resin containing 75 wt % of the PBT and 25 wt % of the soft-polymer (polyester elastomer). The soft-polymer is dispensed into the PBT for applying the impact load carrying capacity. The case is formed by injection molding of the composition of resin. In this comparative example, the impact load carrying capacity is not always enough and the performance requirement of the case is not satisfied.

### \mathring{6} An Embodiment 1A

The embodiment 1A is a case formed by a composition of resin containing 50 wt % of the PBT and 50 wt % of the ABS in accordance with the present invention. The case is formed by injection molding of the composition of resin. The fillers such as the glass fiber are not dispensed. In this embodiment 1A, the impact load carrying capacity is superior and the performance requirement and the quality requirement of the case are satisfied.

### \mathring{7} A Comparative Example 6A

The comparative example 6A is a case formed by a composition of resin which contains denatured PPE (polyphenylene ether) base having a good impact load carrying capacity. The case is formed by injection molding of the composition of resin. In the comparative example 6A, the case has a superior impact load carrying capacity. However, with respect to the other physicality such as the change of dimension due to water absorption, the performance requirement of the case are not satisfied.

As mentioned above, in comparison with the comparative examples 1A to 6A, the case of the embodiment 1A satisfies the quality requirement of the case of the door lock device.

### Injection Molding

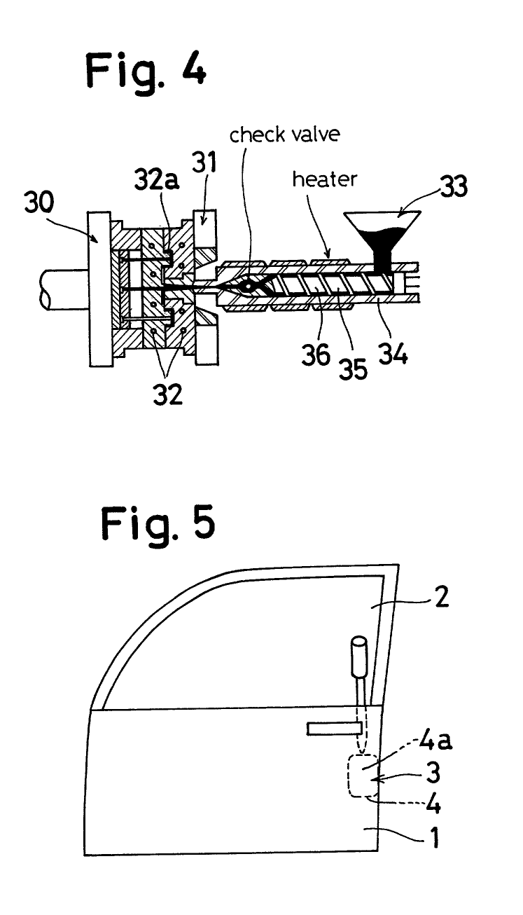

FIG. 4 shows a process of the injection molding.: As shown in FIG. 4, under the condition which a forming molds 32 are held on a movable plate 30 and fixed plate 31, the composition of resin is charged from a hopper 33 to a cylinder hole 35 of a cylinder device 34. The composition of resin is plasticized by the rotation of a screw 36 rotatably held in the cylinder hole 35 and is dissolved. The dissolved composition of resin is injected and charged in a cavity 32a of the forming molds 32 with a predetermined injection pressure and a thin-walled case is formed. In this case, the temperature in the outlet of the cylinder device 34 is 200 to 250° C., especially 220 to 220° C. The injection pressure is 20 to 100 MPa, especially 30 to 70 MPa. The temperature of the forming molds is 40 to 120° C., especially 40 to 80° C. The temperature in the outlet of the cylinder device 34 corresponds to the temperature of the, composition of resin at the injection molding substantially.

### Application Form

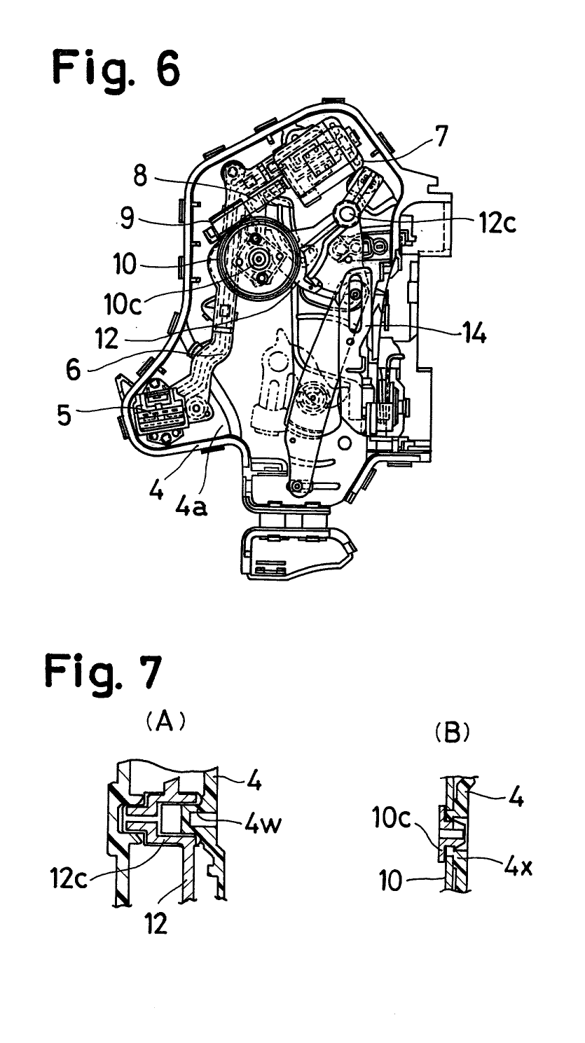

FIG. 5 to FIG. 7 show an embodiment in which an actuator device in accordance with the present invention is applied to a door lock device 3. The door lock device 3 is mounted on a door 1 and is located below a window opening 2. The door lock device 3 includes a case 4 which has an accommodating chamber 4a. In this embodiment, the thickness of the case 4 is less than 4 mm. As shown in FIG. 6, in the accommodating chamber 4a of the case 4 formed by injection molding of the composition of resin in accordance with the present invention, an electricity feeding portion 5, a drive motor 7 fed electricity from the electricity feeding portion 5 through a feeding cable 6, a worm gear 9 held on a motor shaft 8 of the drive motor 7, a wheel gear 10 engaged with the worm gear 9, an active lever 12 and a lock member 14 are built in. When the drive motor 7 is rotated, the motor shaft 7 is rotated and the worm gear 9 is rotated. As a result, the wheel gear 10 which engages with the worm gear 9 is rotated around a rotational shaft 10c. Thereby, the active lever 12 swings around a rotational shaft 12c and the engagement and disengagement function of the lock member 14 is performed. The rotational shaft 12c of the active lever 12 is rotatably supported by a bearing portion 4x of the case 4 which has a pipe shape. Since the rotational shafts 10c and 12c are directly and rotatably supported on the bearing portions 4w, 4x which are formed on the case, in order to obtain a good assembly performance, a high rigidity and a high accuracy of dimension are required for the case 4. If the accuracy of dimension of the case decreases, it hinders the assembling of the functional components such as the wheel gear 10, the active lever 12 and so on. Further, in order to ensure the smooth movement of the functional components, grease is applied to the functional components. Therefore, the chemical resistance (organic solvent proof, oil resistance and son on) is requested to the case 4. Further, since there is a case that the door lock device 3 is destroyed by a thief which uses a tool and so on, in order to prevent the theft, it is not enough that only the rigidity is high. A moderate flexibility and a high impact load carrying capacity are also requested to the case 4.

According to the case 4 formed by injection molding of the composition of resin containing the PBT and the ABS which are dispensed with a compounding ratio In accordance with the present invention, the chemical resistance, the rigidity and the impact load carrying capacity are satisfied. Accordingly, the case of the embodiment is suitable for use as a case of the door lock device.

Having now fully described the invention, It will be apparent to one of the ordinary skill in the art that many changes and modifications can be made without departing from the spirit or scope of the invention as set forth herein.

What is claimed is:

1. A case formed by injection molding of composition of resin and having an accommodation chamber which is formed therein for holding functional components,
wherein the composition of resin contains from 40 to 70 wt % of polybutylene terephthalate resin (PBT) and from 60 to 30 wt % of acrylonitrile-butadiene-styrene (ABS).

2. A case according to claim 1, wherein the polybutylene terephthalate resin (PBT) is appeared on the surface of the case with high frequency.

3. A case according to claim 2, wherein the area on which the polybutylene terephthalate resin (PBT) Is appeared is more than 95% of the surface area of the case.

4. A case according to claim 1, wherein the composition of resin contains from 40 to 50 wt % of polybutylene terephthalate resin (PET) and from 60 to 50 wt % of acrylonitrile-butadiene-styrene (ABS).

5. An actuator device comprising:
a case forming a accommodation chamber; and
functional components disposed in the accommodation chamber;
wherein the case is formed by injection molding of composition of resin which contains from 40 to 70 wt % of polybutylene terephthalate resin (PBT) and from 60 to 30 wt % of acrylonitrile-butadiene-styrene (ABS).

6. An actuator device according to claim 5, wherein the polybutylene terephthalate resin (PBT) is appeared on the surface of the case with high frequency.

7. An actuator device according to claim 6, wherein the area on which the polybutylene terephthalate resin (PBT) is appeared is more than 95% of the surface area of the case.

8. An actuator device according to claim 5, wherein the composition of resin contains from 40 to 50 wt % of polybutylene terephthalate resin (PBT) and from 60 to 50 wt % of acrylonitrile-butadlene-styrene (ABS).
